(19) United States
(12) Patent Application Publication
(10) Pub. No.: US 2024/0241013 A1
(43) Pub. Date: Jul. 18, 2024

(54) TEST WHEEL FOR A DRIVE TRAIN TEST BENCH AND DRIVE TRAIN TEST BENCH

(71) Applicant: ZF Friedrichshafen AG, Friedrichshafen (DE)

(72) Inventors: Sebastian Weber, Thyrnau (DE); Sebastian Egner, Regen (DE)

(73) Assignee: ZF Friedrichshafen AG, Friedrichshafen (DE)

(21) Appl. No.: 18/562,033

(22) PCT Filed: May 10, 2022
(86) PCT No.: PCT/EP2022/062591

§ 371 Date: Nov. 17, 2023

(30) Foreign Application Priority Data
May 20, 2021 (DE) 10 2021 205 144.8

(51) Int. Cl. G01M 17/007

(52) U.S. Cl. CPC G01M 17/007

(57) ABSTRACT

A test wheel for a drivetrain test bench has a wheel rim, a wheel mounting, a blocking device, a wheel hub, and a wheel hub rotationally fixed on a wheel shaft. The wheel shaft and the wheel hub are held rotatably in the wheel rim by the wheel mounting, the blocking device is rotationally fixed to the wheel rim, and the wheel shaft can be rotationally fixed by a first connecting flange to a drive output shaft of a drivetrain to be tested. The wheel hub can be rotationally fixed by a second connecting flange to a drive input shaft and rotationally fixed to the blocking device by a third connecting flange so that rotation of the wheel shaft relative to the wheel rim is blocked. The third connecting flange can only be connected when the second connecting flange is not connected. A corresponding drivetrain test bench is disclosed.

### RELATED APPLICATIONS

This application claims the benefit under 35 U.S.C. § 371 as a U.S. National Phase application of application no. PCT/EP2022/062591, filed on 10 May 2022, which claims benefit of German Patent Application no. 10 2021 205 144.8 filed 20 May 2021, the contents of which are hereby incorporated herein by reference in their entireties.

### FIELD OF THE DISCLOSURE

The invention relates to a test wheel for a drive train test bench and to a corresponding drive train test bench.

### BACKGROUND

Transmission test benches or drive train test benches for testing motor vehicle transmissions or complete motor vehicle drive trains are known from the prior art. Such test benches are usually used for quality control in order to recognize functional defects in drive trains at an early stage by means of a series of load tests. Typical functional defects arise, for example, in components liable to operate with play such as gearwheels, synchronizer rings, synchronizer bodies, disk-clutch disks, and shafts, which are driven and can be excited into vibrations. In the context of such functional testing, as a rule the acoustic behavior and the shifting quality are also tested. Moreover, however, such test benches are used in the development and continual improvement of motor vehicle drive trains.

In this connection DE 103 28 461 A1 describes a vehicle test bench with a loading machine for each drivable wheel of a motor vehicle. The loading machines are in this case connected with the wheel rims of the motor vehicle wheels either directly, for example by means of wheel bolts, or indirectly, for example via belt drives, so that the loading machines can both drive and brake the drive train. The test bench of DE 103 28 461 A1 also comprises a frame structure by means of which the motor vehicle and the loading machines are raised and orientated relative to one another. During the testing process the motor vehicle is carried completely by the said frame structure, so the wheels are not in contact with the ground.

U.S. Pat. No. 10,739,234 B2 shows a dynamometer test system for a vehicle, which comprises a dynamometer test unit and an adaptor plate. The adaptor plate can be connected on one side to a wheel hub of a motor vehicle to be tested, so that the vehicle can be supported on the adaptor plate as if on a vehicle tire. On the other side the adaptor plate can be connected to an output shaft of the dynamometer test unit, so that the adaptor plate can form a driving connection between the wheel hub of the vehicle and the output shaft. During a testing process the vehicle together with the adaptor plate is raised, so that the adaptor plate does not touch the ground. A rubber layer can also be arranged on a radial circumference of the adaptor plate.

From EP 2 187 193 B1 a simulation wheel is known, which can be fitted by way of a hub fixing structure such as a vehicle tire to the hub of a motor vehicle. Opposite the hub fixing structure is a shaft-holding section that can be connected to a drive unit in order to transmit a torque via the simulation wheel into the hub of the vehicle. A tire-holding section surrounds the shaft-holding section concentrically and serves to fit a tire. Between the shaft-holding section and the tire-holding section a rotary bearing is provided, so that the shaft-holding section can be rotated relative to the tire-holding section. By means of a clutch mechanism the shaft-holding section can be coupled to the tire-holding section so that they can no longer rotate relative to one another.

AT 517 842 A4 describes a test wheel with a wheel disk, which merges into a wheel disk bush. In the wheel disk bush a fixing flange is mounted rotatably, which can be connected on one side to a wheel hub of a motor vehicle and on the other side to a driveshaft connecting flange of a drive unit in order to form a driving connection between the wheel hub and the drive unit. The rotatability of the wheel disk relative to the fixing flange can be blocked by axially displaceable locking means which are arranged rotationally fixed on the fixing flange and are designed, when in an engaged position, to form a rotationally fixed and interlocking connection with the wheel disk bush. In a disengaged position of the locking means, in contrast, the fixing flange can rotate relative to the wheel disk bush.

### SUMMARY

However, the known test wheels have the disadvantage that they cannot reliably prevent an inadvertent blocking of the rotatability of the inside part of the test wheel during the testing process relative to the outer part, which is static during the testing process. Should such an inadvertent blocking occur during a testing process the outer part of the test wheel will also move, so that the vehicle being tested undergoes a sudden and unwanted translation movement, which can result in damage to the drive train test bench, the drive train, or the vehicle being tested, and possibly to people as well.

The purpose of the present invention is to propose an improved test wheel for a drive train test bench.

According to the invention, that objective is achieved by the test wheel for a drive train test bench disclosed herein. Advantageous design features will be apparent from the present disclosure.

The invention relates to a test wheel for a drive train test bench, comprising a wheel rim, a wheel mounting, a blocking device, a wheel shaft, and a wheel hub, wherein the wheel hub is fitted rotationally fixed on the wheel shaft, wherein the wheel shaft and the wheel hub are held rotatably in the wheel rim by means of the wheel mounting, wherein the blocking device is connected rotationally fixed to the wheel rim, wherein the wheel shaft is designed to be connected rotationally fixed by way of a connecting flange to a driveshaft of a drive train to be tested, and wherein the wheel hub is designed to be connected rotationally fixed by way of a second connecting flange to a driveshaft of the drive train test bench. The test wheel according to the invention is distinguished in that the wheel hub is also designed to be connected rotationally fixed to the blocking device by means of a third connecting flange so that the rotatability of the wheel shaft relative to the wheel rim is blocked, but the third connecting flange can only be connected when the second connecting flange is not connected.

Thus, the invention describes a test wheel for a drive train test bench. The drive train test bench is suitable for testing a drive train of a motor vehicle. The drive train can equally well be a drive train powered by an electric motor or a conventionally powered drive train.

The test wheel comprises a wheel rim, a wheel mounting, a blocking device, a wheel shaft, and a wheel hub, wherein its constituents can in turn each consist of a series of sub-constituents. By virtue of the wheel mounting, the wheel rim can rotate relative to the wheel shaft and the wheel hub. The wheel shaft and the wheel hub are arranged concentrically inside the wheel mounting and the wheel rim.

It is preferably provided that the wheel shaft and the wheel hub are connected rotationally fixed to one another by means of spline teeth, and the wheel hub is secured axially on the wheel shaft by axial securing means. The connection by means of spline teeth advantageously enables the transfer even of very large torques. The axial securing means can, for example, be in the form of a locking ring fitted onto the wheel shaft in a groove, which prevents the wheel hub from slipping off the wheel shaft.

Alternatively preferred, it is provided that the wheel shaft and the wheel hub are connected rotationally fixed by means of a feather key. Connection by a feather key is comparatively inexpensive.

Thus, the radially outer part of the test wheel, which consists essentially of the wheel rim, can rotate relative to the radially inner part, which consists essentially of the wheel shaft and the wheel hub. This advantageously makes it possible for the test wheel to be mounted on the motor vehicle like an ordinary wheel for the process of testing the drive train, while the motor vehicle is supported on the test wheel during the testing process.

The drive train to be tested, or the motor vehicle to be tested, is thus supported by its suspension on the test wheel which, for its part, is standing on a substrate where it supports the gravitational force acting upon it. This makes for realistic test behavior that corresponds, during the testing process, as closely as possible to the actual vehicle behavior.

The substrate can have a particularly high coefficient of friction relative to the test wheel, in order to enable the transfer of large torques from the loading motor to the test wheel.

Furthermore, it can be provided that the test wheel can be connected by friction or with interlock to a substrate. For example, the adhesion of the test wheel to the substrate can be increased still more if the test wheel is clamped around its circumference, possibly by means of a tension belt whose ends are fixed to the substrate. To improve the adhesion of the test wheel to the substrate even further, the test wheel can be fixed to the substrate, for example, by a bolt arranged in the substrate and projecting radially outward so that it penetrates into the test wheel. Moreover, a special fixing structure such as a tie-rod or pushrod can be connected to the outer portion of the test wheel which is static during the testing operation. In that case the tie-rod or pushrod is connected to the substrate.

The blocking device is connected rotationally fixed to the wheel rim, wherein the connection of the blocking device to the wheel rim can be made directly—i.e., without further components—or indirectly—i.e., using further components. For example, the blocking device can be screwed directly to the wheel rim. Likewise, it is conceivable and preferred that the blocking device and the wheel rim are, for example, both screwed to an outer ring of the wheel mounting, so that in this case there is an indirect connection between the blocking device and the wheel rim by way of the wheel mounting.

The wheel shaft has a first connecting flange by means of which it can be connected rotationally fixed to a drive output shaft of a drive train to be tested. The connection to the drive output shaft of the drive train can also be an indirect connection, for example by way of a wheel hub of a motor vehicle on which a vehicle wheel is usually mounted and which is arranged rotationally fixed on the drive output shaft. As already described, the test wheel can in that way be fitted in place of an ordinary vehicle wheel and in the manner of an ordinary wheel. Advantageously, the first connecting flange is correspondingly a flange with a connection pattern the same as on a conventional wheel rim. The test wheel can then be mounted onto the wheel hub of the motor vehicle by way of the first connecting flange using conventional wheel bolts.

Thus, the first connecting flange has a flange surface on the wheel shaft of the test wheel, a flange surface on the wheel hub of the motor vehicle, and a number of bolts for forming the flange connection.

On the wheel hub of the test wheel a second connecting flange is provided, which enables a rotationally fixed connection to a drive input shaft of the drive train test bench. The second connecting flange is preferably arranged on the axial side of the test wheel opposite the first connecting flange, i.e., during testing operation the drive output shaft of the drive train and the drive input shaft are on opposite axial sides of the test wheel. Thus, by way of the second connecting flange the drive input shaft can transmit a torque and a rotation speed to the wheel hub of the test wheel, which is connected rotationally fixed to the wheel shaft of the test wheel. The torque and the rotation speed are correspondingly transmitted to the wheel shaft, which for its part transmits the torque and the rotation speed via the first flange connection to the drive train to be tested.

To drive the drive input shaft, the drive train test bench advantageously comprises an electric motor. Electric motors are comparatively compact, particularly compared with internal combustion engines, they have a wide range of rotation speeds, and they advantageously produce the maximum torque over a broad range.

Particularly preferably, the second connecting flange has bolt holes with an internal thread in the wheel hub. In that way there is only one parting joint when the second connecting flange is connected, i.e., when the drive input shaft is connected to the wheel hub.

Thus, the second connecting flange has a flange surface on the wheel hub of the test wheel, a flange surface at an axial end of the drive input shaft, and a number of bolts for forming the flange connection.

Since the wheel shaft and the wheel hub are held rotatably in the wheel rim by the wheel mounting, the vehicle whose drive train is being tested can remain at rest during testing operation, i.e., it can remain stationary since the wheel rim remains unaffected by the torque and the rotation speed introduced.

According to the invention, it is now provided that the wheel hub is also designed to be connected rotationally fixed to the blocking device by way of a third connecting flange. Thus, besides the second connecting flange, with the said third connecting flange the wheel hub has a further connecting flange.

Since the wheel hub can be connected via the third connecting flange to the blocking device and in turn the blocking device is connected rotationally fixed to the wheel rim, the rotatability of the wheel shaft and the wheel hub relative to the wheel rim can be blocked by way of the third connecting flange. A torque and a rotation speed transmitted by the wheel shaft or by the wheel hub are therefore also transmitted to the wheel rim and result in a rotation of the wheel rim, which in turn, when the test wheel is mounted on the motor vehicle, results in a translational movement of the motor vehicle. Thus, it is advantageously possible that the motor vehicle with the test wheel fitted can move under its own power, for example to a predetermined test position in a testing workshop.

Thus, the third connecting flange comprises a flange surface on the wheel hub of the test wheel, a flange surface on the wheel rim or a component connected rotationally fixed to the wheel rim, and a number of bolts for forming the flange connection.

The blocking device is thus in the form of a flange connection, which has the further advantage that, compared with blocking devices known from the prior art, it is axially comparatively short. In particular, a movement process of the motor vehicle with the test wheel fitted can be simplified in that there are no parts projecting laterally far out from the motor vehicle, which would demand greater attention and care by the driver of the motor vehicle.

For example, as part of a testing process the test wheel can be fitted onto the motor vehicle at a first location, and then the actual testing of the drive train can take place at a second location and the test wheel can be taken off at a third location. When the wheel hub is connected rotationally fixed to the blocking device by means of the third connecting flange, the motor vehicle can move under its own power from the first to the second location and from there to the third location, which simplifies and speeds up the testing sequence.

According to the invention, it is also provided that owing to the arrangement of the second connecting flange and the third connecting flange, the third connecting flange can only be connected when the second connecting flange is not connected. This is ensured since, advantageously, the second and the third connecting flanges are both arranged on the wheel hub and have different connection patterns. In other words, the second and the third connecting flanges are arranged on the wheel hub in a superimposed manner and have different connection patterns.

In the context of the invention a connection pattern is understood to mean the diameter and depth of the bolt openings, the circumference on which the bolt openings are arranged, the spacing apart of the bolt openings and the number of bolt openings. For example, the bolt openings can be through-going bores with no thread, or blind holes with a thread.

The superimposition of the second and third connecting flanges is advantageous in that the second connecting flange can also only be connected when the third connecting flange is not connected.

Thus, when the second connecting flange is connected to the drive input shaft, advantageously the bolt openings of the third connecting flange are covered by the drive input shaft and inaccessible, in such manner that the third connecting flange cannot be connected. Conversely, when the third connecting flange is connected, i.e., when the blocking device is activated, for example, bolt heads project axially out of the bolt openings of the third connecting flange in such manner that in turn the drive input shaft cannot be connected to the second connecting flange.

Thus, by virtue of a clever superimposition of the connection patterns of the second and third connecting flanges, the invention prevents the two of them from being connected at the same time. Accordingly, in a simple manner it is made impossible for a torque introduced into the wheel hub and the wheel shaft during a testing process to be transmitted to the wheel rim, which would result in a sudden and undesired translational movement of the motor vehicle.

Furthermore, since the blocking device is an integral part of the area of the test wheel, which is static during testing operation and can only be activated by bolting on the third connecting flange, it is not necessary to fit any further components in order to block the rotatability of the wheel rim relative to the wheel shaft and the wheel hub. Thus, the torsional moment of inertia of the wheel shaft is also not increased disadvantageously.

A further substantial advantage of the invention can be regarded as that the testing process by means of the test bench according to the invention, and in particular also the chassis properties of the motor vehicle to be tested, are to a very great extent uninfluenced, since during the testing process the motor vehicle to be tested is supported exclusively by its chassis. Advantageously therefore, chassis-specific properties such as the jouncing behavior, the steering behavior, and similar properties can be tested realistically.

According to a preferred embodiment of the invention it is provided that threaded bores of the second connecting flange have either a larger or a smaller diameter than threaded bores of the third connecting flange. In that way, bolts that serve to close the second connecting flange cannot be inadvertently screwed into the threaded bores of the third connecting flange, and vice-versa. An inadvertent closing of the second flange connection or above all of the third flange connection, and along with that, an undesired activation of the blocking device, can in that way be excluded.

In another preferred embodiment of the invention, it is provided that the wheel mounting comprises a wheel bearing and a bearing housing, wherein the wheel bearing is secured axially on the wheel hub by axial securing means and is supported against the bearing housing by means of a contact disk. The axial securing means advantageously prevents any axial displacement of the inner bearing ring, and the contact disk reduces the play of the outer bearing ring.

The wheel bearing is preferably a double-row angular contact ball bearing in an O-arrangement. Alternatively preferred, it can also consist of two single-row ball bearings or angular contact ball bearings.

According to a further preferred embodiment of the invention, it is provided that the bearing housing and/or the rim has at least one opening through which at least one screw of the first flange connection can be accessed. This has the advantage that the test wheel can be mounted on the wheel hub of the motor vehicle quickly and simply, and in particular, to enable mounting on the wheel hub the test wheel itself does not have to be fully or partially taken off.

In a further preferred embodiment of the invention, it is provided that the wheel rim comprises a rim base and a rim disk, wherein the rim base is screwed to the rim disk. In that way a rim base of a conventional vehicle rim can be connected to the rim disk, which in turn allows the use of conventional, inexpensive vehicle tires, in particular ones approved for roadway use. This also makes for especially realistic testing behavior of the drive train during the testing process.

According to a particularly preferred embodiment of the invention, it is provided that the rim base comprises an outer rim base and an inner rim base, wherein the outer rim base and the inner rim base are screwed individually to the rim disk. In that way the rim base can be adapted very flexibly to various tire types, in particular in relation to offset and tire width.

In a further preferred embodiment of the invention, it is provided that the wheel rim comprises a rim base and a rim disk such that the rim base and the rim disk are made integrally as one piece. This allows comparatively inexpensive production of the wheel rim.

According to a further preferred embodiment of the invention, it is provided that the rim disk and the bearing housing are made integrally. This too enables comparatively inexpensive production of the test wheel. In addition, the fitting effort when mounting the test wheel is reduced.

In another preferred embodiment of the invention, it is provided that the wheel rim and the bearing housing are made integrally. In that case the production of the test wheel is particularly inexpensive, and the fitting effort is particularly small.

According to a further preferred embodiment of the invention, it is provided that a pneumatic tire is arranged on the rim base. In that case the supporting behavior of the test wheel on the substrate corresponds as closely as possible to the supporting behavior that occurs during the normal driving operation of the motor vehicle. In that way the quality of the test can be improved since the behavior of the drive train in the testing situation is even closer to its behavior during the normal driving operation of the motor vehicle.

Preferably a pneumatic tire is fitted on the test wheel, which tire is also approved for road use of the motor vehicle during its operation.

According to an alternative preferred embodiment of the invention, it is provided that a rubber coating is arranged on the rim base. The rubber coating also enables comparatively realistic supporting of the test wheel on the substrate, but in contrast to the pneumatic tire, it does not require any separate selection and mounting of a respectively suitable pneumatic tire on the test wheel. Instead, the rubber coating can be arranged firmly and permanently on the rim base.

In a further preferred embodiment of the invention it is provided that the blocking device comprises a ring gear and a spur gear, wherein the spur gear and the ring gear are connected rotationally fixed to one another by means of spline teeth, in that the spur gear is arranged in the ring gear, wherein the spur gear can be displaced axially relative to the ring gear within the blocking device without disengaging the spline teeth, and wherein the spur gear is pressed by the action of spring force into axial contact with the contact disk. The spur gear and the ring gear remain engaged by virtue of the spline teeth regardless of the condition of the blocking device, i.e., regardless of whether it is or is not blocking the rotatability of the wheel rim relative to the wheel hub. By virtue of the axial displacement of the spur gear in the ring gear, and the action of spring force on the spur gear so that the spur gear is pushed into contact with the contact disk, when the drive input shaft is connected to the wheel hub by means of the second connecting flange there is an air gap between the axial end of the spur gear and the wheel hub so that during testing operation the spur gear does not grind against the wheel hub.

The spring force can be exerted, for example, by a star spring or a spiral spring.

According to a further preferred embodiment of the invention, it is provided that the spur gear can be connected to the wheel hub by means of the third connecting flange. Thus, when the third connecting flange is connected, the bolts of the third flange connection advantageously engage in threaded bores in the spur gear through bolt openings in the form of through-going bores in the wheel hub and pull the spur gear against the action of spring force into contact with the wheel hub so that a frictional and interlocked connection is produced.

The invention further relates to a test bench for a drive train, comprising at least one test wheel according to the invention.

Preferably, it is provided that the test bench comprises a test wheel according to the invention and a wheel loading machine for each of the drivable wheels of the motor vehicle or the drive train.

### BRIEF DESCRIPTION OF THE DRAWINGS

Below, examples of the invention are explained with reference to embodiments illustrated in the figures, which show:

FIG. 1: As an example and schematically, a possible embodiment of a drive train test bench with four test wheels according to the invention.

FIG. 2: As an example and schematically, a further possible embodiment of a drive train test bench with four test wheels according to the invention,

FIG. 3: As an example and schematically, a possible embodiment of a test wheel according to the invention for a drive train test bench,

FIG. 4: As an example, a possible embodiment of the connection pattern of the second connecting flange and the connection pattern of the third connecting flange,

FIG. 5: The test wheel of FIG. 3, but without the connected universal joint shaft,

FIG. 6: As an example and shown in section, the spring of the test wheel of FIG. 3,

FIG. 7: Also as an example and shown in section, the spring of the test wheel of FIG. 3,

FIG. 8: As an example and schematically, a further possible embodiment of a test wheel according to the invention for a drive train test bench,

FIG. 9: As an example and schematically, a further possible embodiment of a test wheel according to the invention for a drive train test bench.

FIG. 10: As an example and schematically, a further possible embodiment of a test wheel according to the invention for a drive train test bench,

FIG. 11: As an example and schematically, a further possible embodiment of a test wheel according to the invention for a drive train test bench,

FIG. 12: As an example and schematically, a further possible embodiment of a test wheel according to the invention for a drive train test bench,

FIG. 13: As an example and schematically, a further possible embodiment of a test wheel according to the invention for a drive train test bench,

FIG. 14: As an example and schematically, a further possible embodiment of a test wheel according to the invention for a drive train test bench, and

FIG. 15: As an example and schematically, a further possible embodiment of a test wheel according to the invention for a drive train test bench.

In all the figures, the same objects, functional units and comparable components are denoted by the same indexes. These objects, functional units and comparable components are designed identically as regards their technical features unless otherwise indicated explicitly or implicitly in the description.

### DETAILED DESCRIPTION

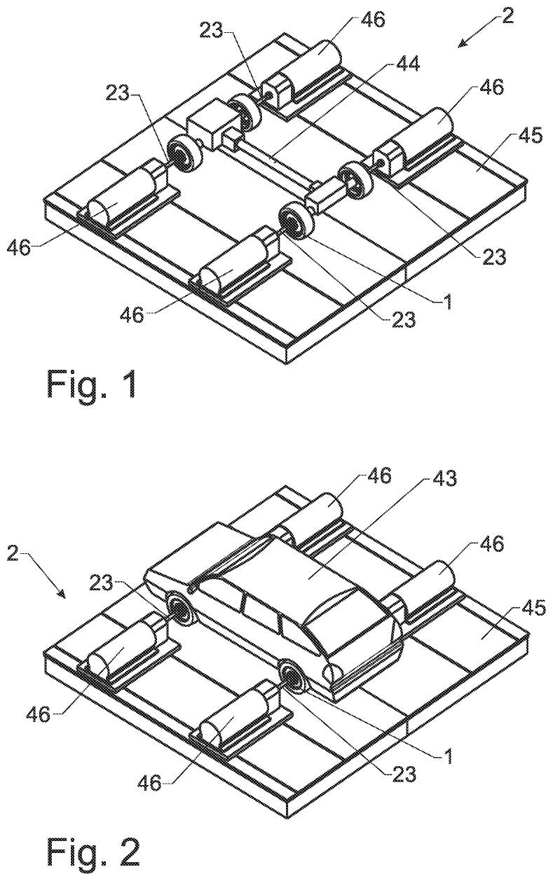

FIG. 1 shows, as an example and schematically, a possible embodiment of a drive train test bench 2 with four test wheels 1 according to the invention. With the help of such a drive train test bench 2, among other things, the function, safety, efficiency, and lifetime of the vehicle components belonging to the drive train 44 under exactly repeated loading conditions can be investigated and tested. For that purpose, the drive train 44 is fixed onto a test bed 45. The drive train 44 is provided with four test wheels 1, according to the invention, and which are connected by drive input shafts 23 from the test bench side, designed as universal shafts, to four-wheel loading machines 46 for the transmission of power. In this example the wheel loading machines 46 are electric motors 46. During testing operation each test wheel 1 enables the transfer of rotation speed and torque between the respective wheel hubs of the drive train 44 and the wheel loading machines 46. By virtue of a wheel mounting 8 a radially outer part of each test wheel 1, which consists, for example, of the vehicle tire 6 and the test wheel rim 7, has a rotary joint relative to the wheel shaft 10 and therefore provides a degree of rotational freedom, whereas the outer part is static relative to the wheel shaft 10 of the test wheel 1. The weight of the drive train 44 is transferred via the fitted test wheels 1 to the substrate as a wheel load. By virtue of the vehicle tires 6 fitted, during testing operation wheel contact properties very similar to those in real operation are obtained owing to the specific rigidity and damping of the vehicle tires 6.

FIG. 2 shows, as an example and schematically, a further possible embodiment of a drive train test bench 2 with four test wheels 1 according to the invention. However, in the example embodiment of FIG. 2, instead of only a drive train 44, a complete motor vehicle 43 is arranged on the test bench 2. In principle the motor vehicle 43 can move forward under its own power. To make that ability usable also for the arrangement of the motor vehicle 43 on the test bench 2, the test wheels 1 fitted on the motor vehicle 43 each comprise a blocking device 9 by means of which a rotation of the radially outer part of the test wheel 1 relative to the wheel shaft 10 of the test wheel 1 can be blocked. Thus, the motor vehicle 43 can move onto the test bench 2 as if on ordinary tires.

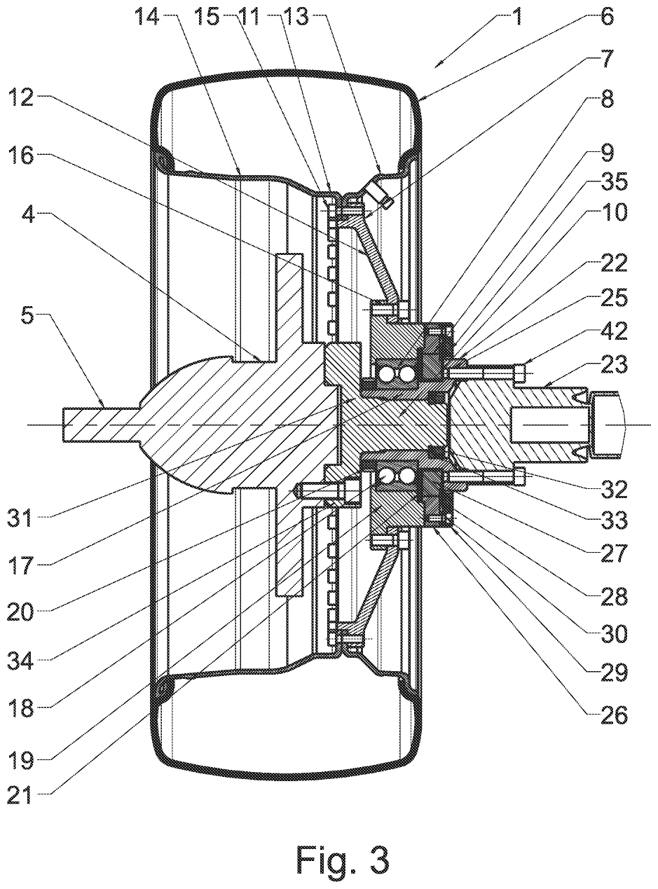

FIG. 3 shows, as an example and schematically, a possible embodiment of a test wheel 1 according to the invention for a drive train test bench 2. The test wheel 1 can be fitted onto a wheel hub of the motor vehicle 43 or the drive train 44.

The test wheel 1 in this example consists of a vehicle tire 6, a test wheel rim 7, a wheel mounting 8, a blocking device 9, a wheel shaft 10, and a wheel hub 17.

The test wheel rim 7 in this example consists of a rim base 11 and a rim disk 12. The rim base 11, for its part, can be made of several components and can consist of an outer rim base 13 and an inner rim base 14. The outer rim base 13, the inner rim base 14 and the rim disk 12 are connected rotationally fixed to one another by screws 15. The screws 15 can in this example be fitted from the direction of the inner rim base 14. Alternatively, it is also conceivable for the screws 15 to be fitted from the direction of the outer rim base 13. The test wheel rim 7 is connected rotationally fixed to the wheel mounting by screws 16.

For its part, the wheel mounting 8 consists of the wheel hub 17, the wheel bearing 18, and the bearing housing 19. The wheel bearing 18 can consist of one or more bearings and is fixed on the wheel hub 17 by axial securing means 20. The wheel bearing 18 is in addition secured axially in the bearing housing 19 by a contact disk 21. In this example, the wheel bearing 18 is a double-row angular contact ball bearing in an O-arrangement.

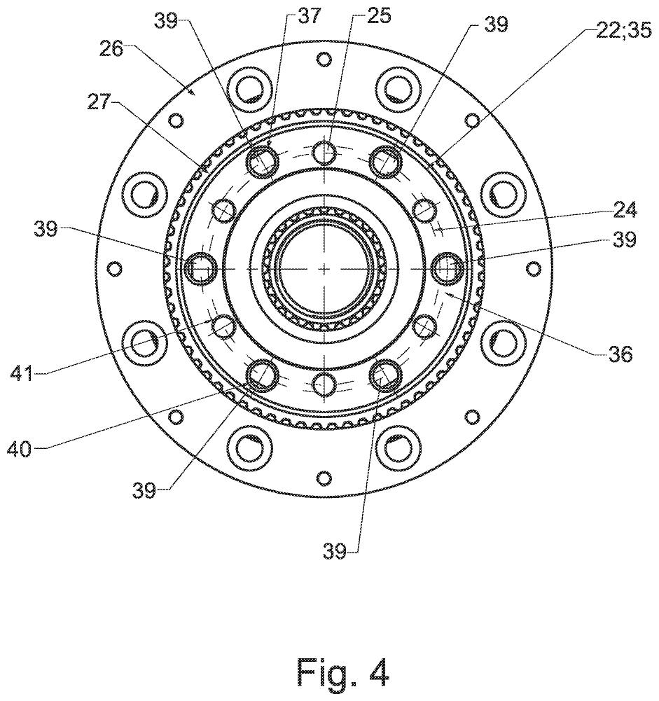

The wheel hub 17 has a second connecting flange 22 for attaching a universal shaft 23 from the test bench side. The connection pattern 24 (see FIG. 4) on the connecting flange 22 has threaded bores 25 for that purpose.

The blocking device 9 consists of a ring gear 26 with internal teeth, N in number, which meshes with a spur gear 27 having external teeth, also N in number, and thereby is connected rotationally fixed thereto. Relative to the ring gear 28 the spur gear 27 can undergo a relative movement axially. By means of a spring 28 the spur gear 27, relative to the ring gear 26, is brought into axial contact with the contact disk 21. This spring 28 is supported in the cover 29. In this example, the cover 29 is fixed to the ring gear 26 by screws 30. The blocking device 9 is connected rotationally fixed to the wheel mounting 8.

The wheel shaft 10 is connected with interlock to the wheel hub 17 of the wheel mounting 8 by means of spline teeth. Moreover, the wheel hub 17 is secured against axial movement relative to the wheel shaft 10 by axial securing means 32. The axial securing means 32 are in this example supplemented by a contact disk 33. The wheel shaft 10 is connected rotationally fixed to the wheel hub 4 of the motor vehicle 43 or that of the drive train 44 by means of a first connecting flange 34.

To block the wheel mounting 8 and thus to transmit torque and rotation speed from the motor vehicle 43 or the drive train 44 to the test wheel rim 7, the spur gear 27 of the blocking device 9 can be connected, by friction and therefore rotationally fixed, to the third connecting flange 35 of the wheel hub 17 by screws (not shown in FIG. 3). The second connecting flange 22 and the third connecting flange 35 are arranged in a superimposed manner and have respectively different connection patterns (see FIG. 4). The connection patterns of the second connecting flange 22 and the third connecting flange 35 differ, in this example, by the diameter of their bores.

When the third connecting flange 35 is connected, the spur gear 27 slips from its axial contact with the contact disk 21 into axial contact with the connecting flange 22 of the wheel hub 17.

The connection pattern 36 in the second connecting flange 22 is in the form of through-going bores 37. The connection pattern 36 in the spur gear 27 is in the form of threaded bores, such that the threaded bores 39 of the third connecting flange 35 in the spur gear 27 have a larger inside diameter 40 than the outer diameter 41 of the threaded bores 25 in the second connecting flange 22. Thus, an inadvertent blocking of the blocking device 9 when the universal shaft 23 is mounted is in any case prevented, since the screws 42 of the second connecting flange 22 cannot engage in the threaded bores 39 of the third connecting flange 35.

FIG. 4 shows as an example a possible embodiment of the connection pattern 24 of the second connecting flange 22 and the connection pattern 36 of the third connecting flange 35. As can be seen, the two connection patterns 24, 36 each have six threaded bores 25, 39, but the threaded bores of the third connecting flange 35 have a larger inside diameter 40 than the threaded bores 25 of the second connecting flange 22 with their outer diameter 41.

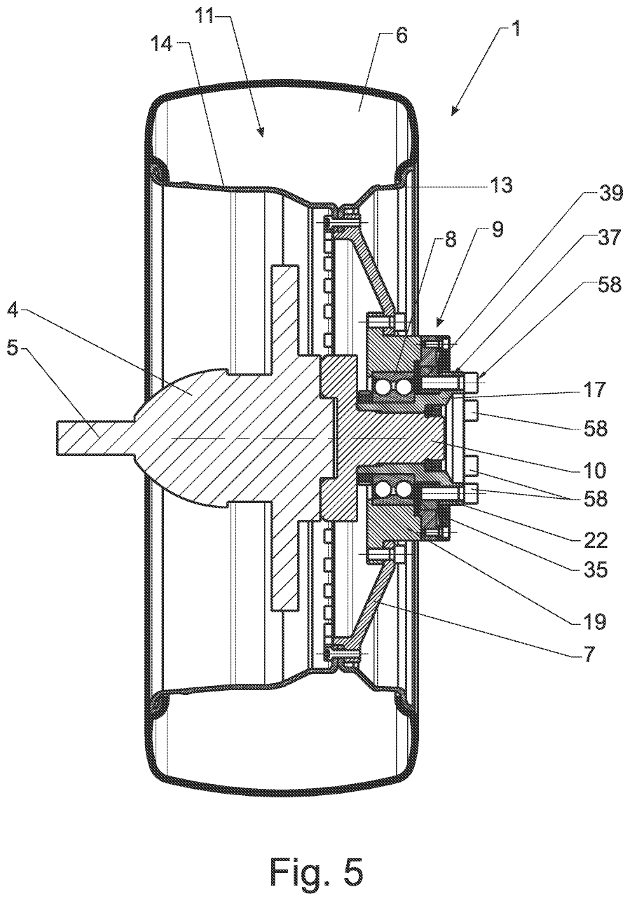

FIG. 5 shows the test wheel of FIG. 3, but without a connected universal shaft 23, i.e., without a closed connection via the second connecting flange 22. Instead, according to FIG. 5 the third connecting flange 35 is connected. For that, screws 58 are fitted into the threaded bores 39 of the connection pattern 36 and passed through the through-going bores 37. Owing to the screw heads of the screws 58, in that condition no universal shaft 23 can be connected.

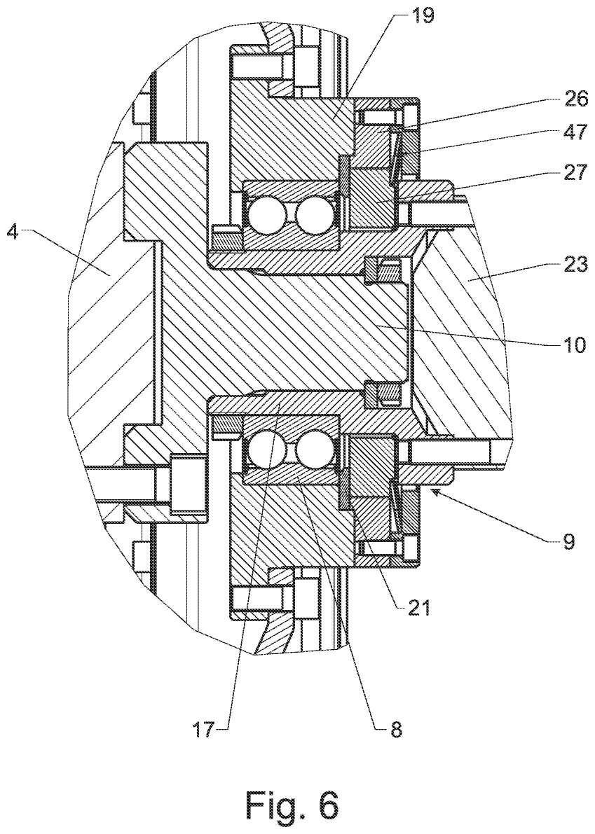

FIG. 6 shows, as an example and schematically, the spring 28 of the test wheel 1 in FIG. 3, wherein the spring 28 in FIG. 6 in this example is in the form of a star spring 47.

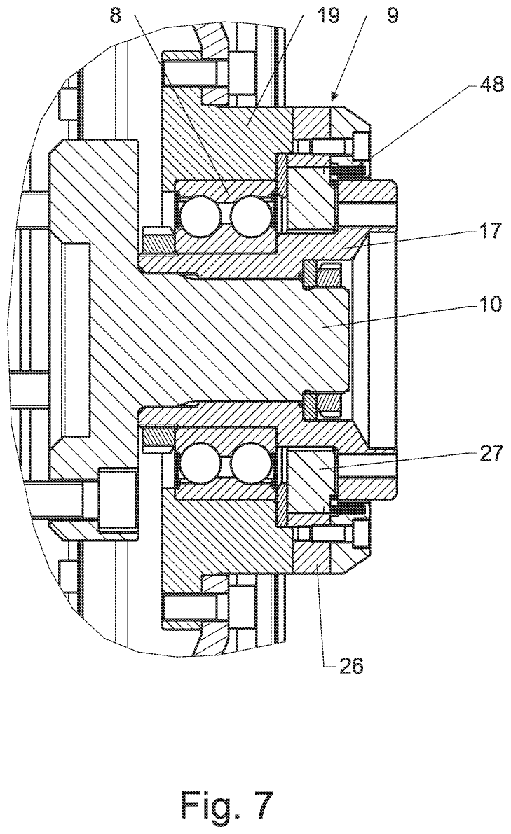

FIG. 7 shows, as an example and schematically, the spring 28 of the test wheel 1 in FIG. 3, wherein the spring 28 in FIG. 7 in this example is in the form of one of several spiral springs 48.

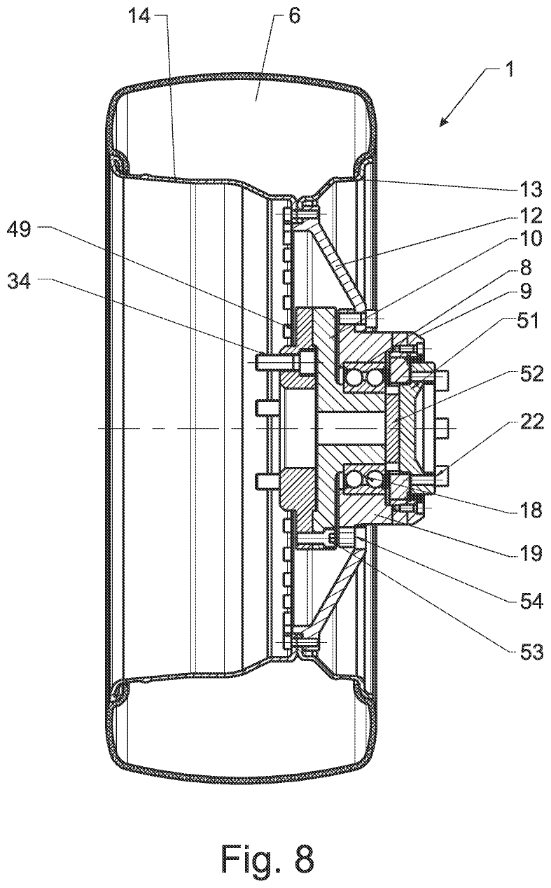

FIG. 8 shows, as an example and schematically, a further possible embodiment of a test wheel 1 according to the invention for a drive train test bench 2. The test wheel 1 in FIG. 8 differs from the test wheel 1 in FIG. 3 in the design of the wheel shaft 10. According to FIG. 8 as well, this can be connected rotationally fixed to the wheel hub 4 (not shown in FIG. 8) by means of the first connecting flange 34. However, in this case the wheel shaft 10 is made in two parts, namely it also comprises the flange 49.

The wheel shaft 10 is connected rotationally fixed to the flange 49 by screws 53. The screws 53 can be fitted via an opening 54 inside the bearing housing 19 and the rim disk 12.

The wheel shaft 10 is connected rotationally fixed, with interlock, to the wheel hub 17 by means of a feather key 52. The wheel hub 17 is additionally connected axially to the wheel shaft 10 by friction.

The wheel bearing 18 is fixed on the wheel shaft 10 and secured axially by the wheel hub 17. The wheel hub 17 can be connected to a universal shaft 23 (not shown in FIG. 8) by means of the second connecting flange 22.

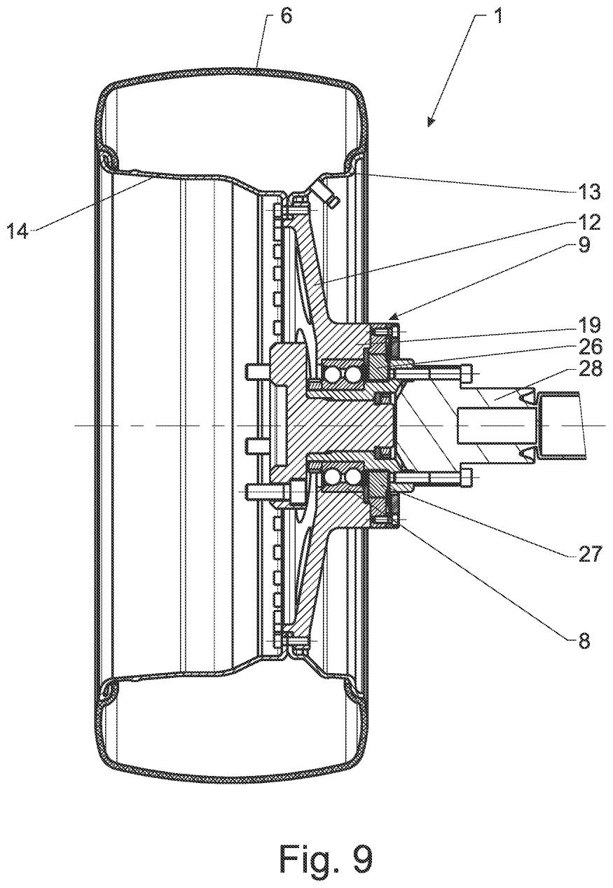

FIG. 9 shows, as an example and schematically, a further possible embodiment of a test wheel 1 according to the invention for a drive train test bench 2. In FIG. 9 the bearing housing 19 and the rim disk 12 are made integrally as one piece.

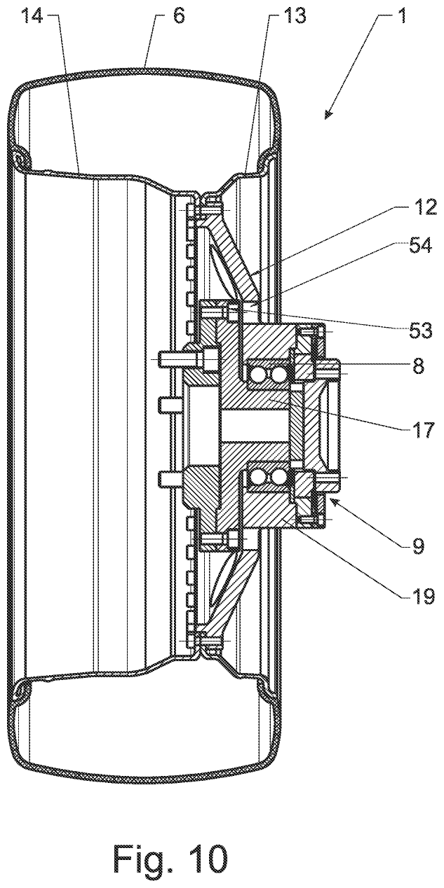

FIG. 10 shows, as an example and schematically, another possible embodiment of a test wheel 1 according to the invention for a drive train test bench 2. In FIG. 10 the bearing housing 19 and the rim disk 12 are again made integrally, but the bearing housing 19 has an opening 54 through which the screws 53 are accessible.

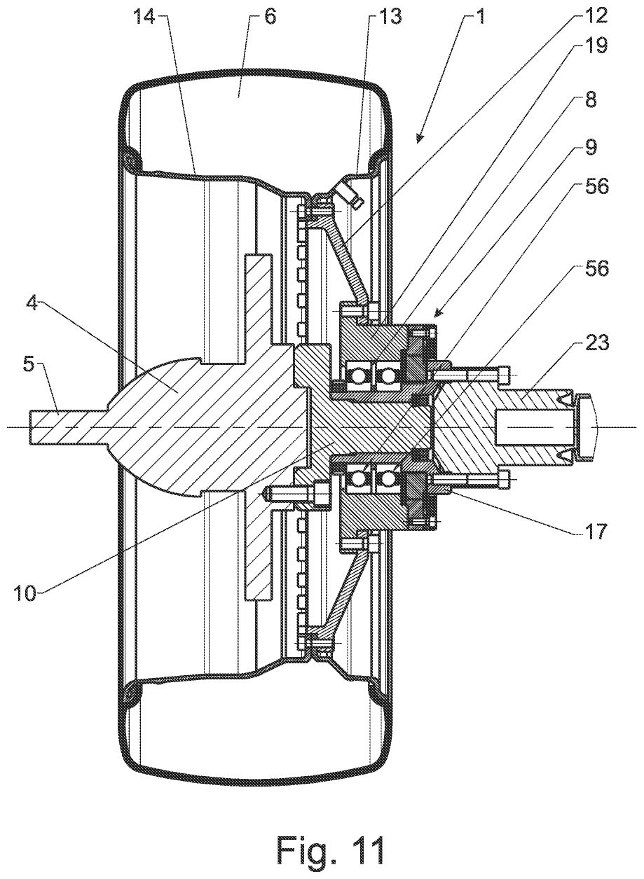

FIG. 11 shows, as an example and schematically, a further possible embodiment of a test wheel 1 according to the invention for a drive train test bench 2. The test wheel 1 of FIG. 11 differs from the test wheel 1 in FIG. 3 in the structure of the mounting 8 as two single-row ball bearings 56.

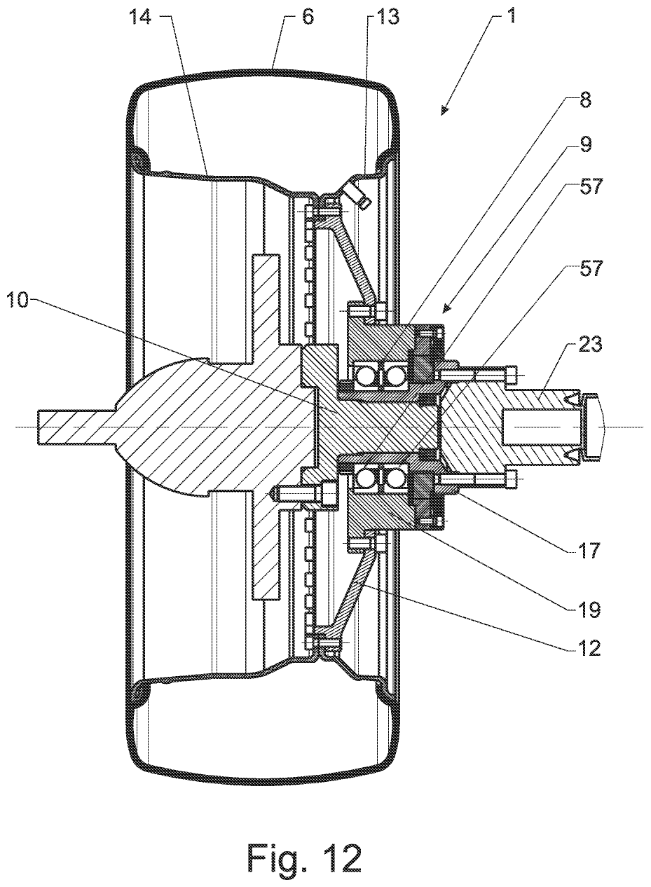

FIG. 12 shows, as an example and schematically, a further possible embodiment of a test wheel 1 according to the invention for a drive train test bench 2. The test wheel of FIG. 12 differs from the test wheel 1 of FIG. 3 in the structure of the mounting 8 as two single-row angular contact ball bearings 57.

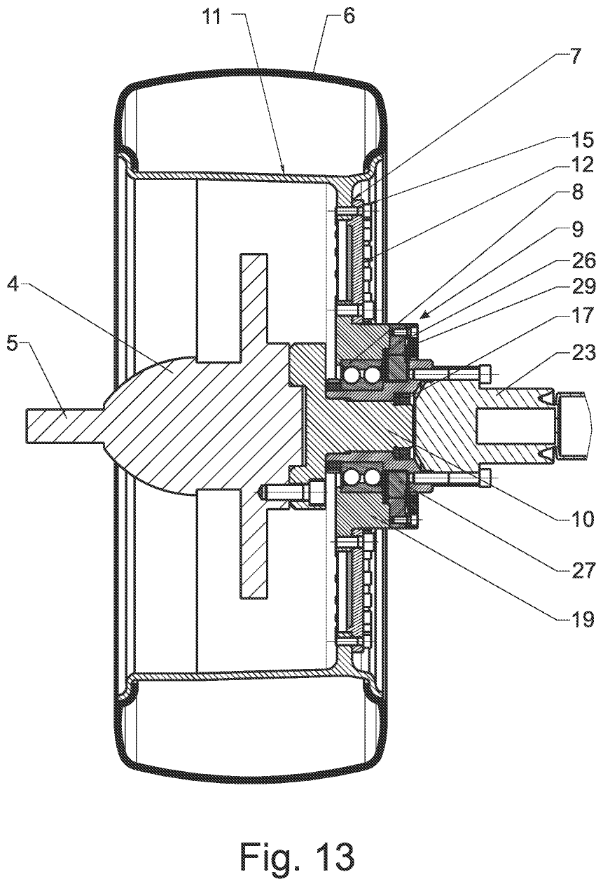

FIG. 13 shows, as an example and schematically, a further possible embodiment of a test wheel 1 according to the invention for a drive train test bench 2. The test wheel of FIG. 13 differs from the test wheel 1 of FIG. 3 in the form of the rim base 11, which in this example is made integrally.

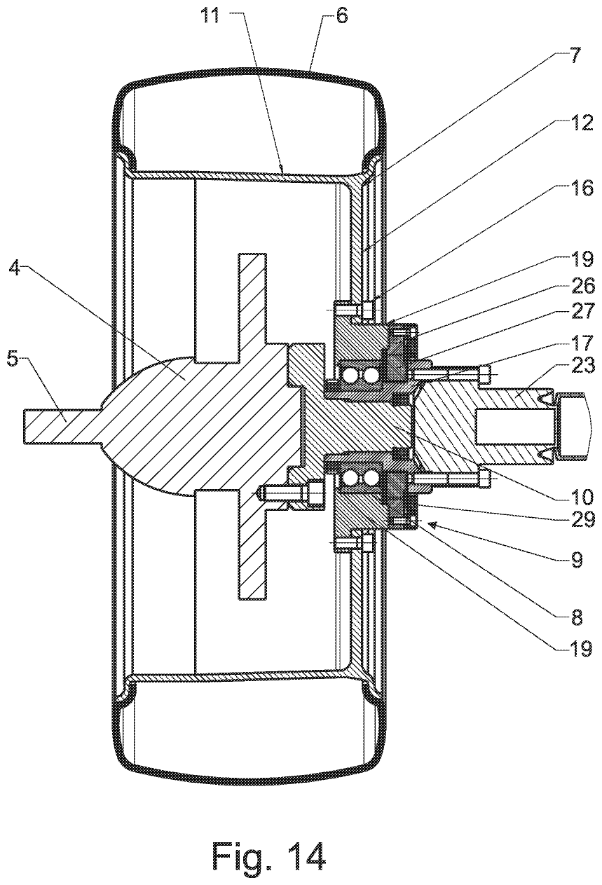

FIG. 14 shows, as an example and schematically, a further possible embodiment of a test wheel 1 according to the invention for a drive train test bench 2. The test wheel of FIG. 14 differs from the test wheel 1 of FIG. 3 in that the rim base 11 and the rim disk 12 are made integrally.

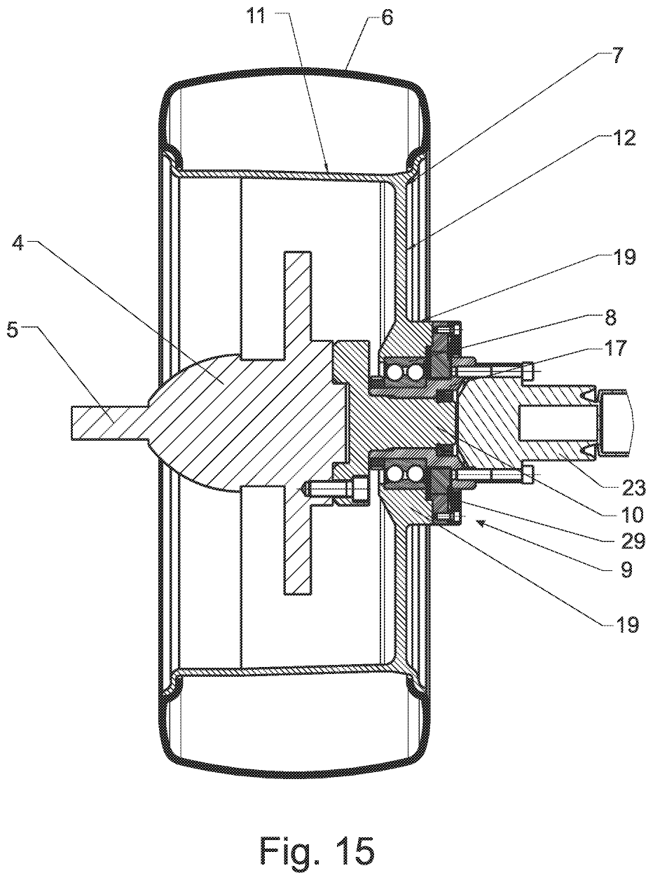

FIG. 15 shows, as an example and schematically, a further possible embodiment of a test wheel 1 according to the invention for a drive train test bench 2. The test wheel 1 of FIG. 15 differs from the test wheel 1 of FIG. 13 in that the rim base 11, the rim disk 12 and the bearing housing 19 are made integrally.

### INDEXES

1 Test wheel
2 Drive train test bench
4 Wheel hub of the motor vehicle
5 Drive output shaft of the motor vehicle
6 Vehicle tires
7 Test wheel rim
8 Wheel mounting
9 Blocking device
10 Wheel shaft
11 Rim base
12 Rim disk
13 Outer rim base
14 Inner rim base
15 Screw connection
16 Screw connection
17 Wheel hub
18 Wheel bearing
19 Bearing housing
20 Axial securing means
21 Contact disk
22 Second connecting flange
23 Drive input shaft, universal shaft
24 Connection pattern
25 Threaded bores
26 Ring gear
27 Spur gear
28 Spring
29 Cover
30 Screw connection
32 Axial securing means
33 Contact disk
34 First connecting flange
35 Third connecting flange
36 Connection pattern
37 Through-going bores
38
39 Threaded bores
40 Inside diameter
41 Outer diameter
42 Screw connection
43 Motor vehicle
44 Drive train
45 Test bed
46 Wheel loading machine
47 Star spring
48 Spiral spring
49 Flange
52 Feather key
53 Screw connection
54 Opening
56 Single-row ball bearing
57 Single-row angled contact ball bearing
58 Screw

1. A test wheel (1) for a drivetrain test bench (2) having a drive input shaft, the test wheel comprising:
a first connecting flange;
a second connecting flange;
a third connecting flange;
a wheel rim (7)
a wheel mounting (8);
a blocking device (9) connected rotationally fixed to the wheel rim (7);
a wheel shaft (10) configured to be connected rotationally fixed by means of the first connecting flange (34) to a drive output shaft (5) of a drivetrain (44) to be tested; and
a wheel hub (17) arranged rotationally fixed on the wheel shaft (10), wherein the wheel hub is configured to be connected rotationally fixed by means of the second connecting flange (22) to the drive input shaft (23) of the drivetrain test bench (2), and the wheel hub (17) is further configured to be connected rotationally fixed to the blocking device (9), by means of the third connecting flange (35), so that rotation of the wheel shaft (10) relative to the wheel rim (7) is blocked, and the third connecting flange (35) can only be connected when the second connecting flange (22) is not connected;
wherein the wheel shaft (10) and the wheel hub (17) are held rotatably in the wheel rim (7) by the wheel mounting (8).

2. The test wheel (1) according to claim 1, wherein the second connecting flange (22) can only be connected when the third connecting flange (35) is not connected.

3. The test wheel (1) according to claim 1, wherein the second connecting flange (22) and the third connecting flange (35) are arranged on the same axial side of the wheel hub (17) and have different connection patterns (24, 36).

4. The test wheel (1) according to claim 3, wherein the connection patterns (24, 36) of the respective second connecting flange (22) and the third connecting flange (35) comprise threaded bores (25, 39), the threaded bores (25) of the second connecting flange (22) having a smaller diameter than the threaded bores (39) of the third connecting flange (35).

5. The test wheel (1) according to claim 1, wherein the wheel mounting (8) comprises a wheel bearing (18) and a bearing housing (19), wherein the wheel bearing (18) is axially secured onto the wheel hub (17) by axial securing means (20) and is supported axially against the bearing housing (19) by means of a contact disk (21).

6. The test wheel (1) according to claim 1, wherein the wheel shaft (10) and the wheel hub (17) are connected rotationally fixed by way of spline teeth, and the wheel hub (17) is secured axially relative to the wheel shaft (10) by axial securing means (32) on the wheel hub (17).

7. The test wheel (1) according to claim 1, wherein the wheel shaft (10) and the wheel hub (17) are connected rotationally fixed by means of a feather key (52).

8. The test wheel (1) according to claim 5, wherein the bearing housing (19) and/or the rim (7) defines at least one opening (54) through which at least one screw (58) of the first connecting flange (34) is accessible.

9. The test wheel (1) according to claim 8, wherein the wheel rim (7) comprises a rim base (11) and a rim disk (12), and the rim base (11) is screwed to the rim disk (12).

10. The test wheel (1) according to claim 9, wherein the wheel rim (7) comprises a rim base (11) and a rim disk (12), and the rim base (11) and the rim disk (12) are made integrally.

11. The test wheel (1) according to claim 10, wherein the rim base (11) comprises an outer rim base (13) and an inner rim base (14), and the outer rim base (13) and the inner rim base (14) are screwed to the rim disk (12).

12. The test wheel (1) according to claim 11, wherein the rim disk (12) and the bearing housing (19) are made integrally.

13. The test wheel (1) according to claim 11, wherein the wheel rim (7) and the bearing housing (19) are made integrally.

14. The test wheel (1) according to claim 1, wherein the blocking device (9) comprises a ring gear (26) and a spur gear (27), wherein the spur gear (27) and the ring gear (26) are connected rotationally fixed to one another by means of spline teeth, in that the spur gear (27) is arranged inside the ring gear (26), wherein the spur gear (27) can be displaced axially relative to the ring gear (26) inside the blocking device (9) without disengaging the spline teeth, and wherein the spur gear (27) is configured to be pressed by the action of spring force into axial contact with the contact disk (21).

15. The test wheel (1) according to claim 14, wherein the spur gear (27) is configured to be connected to the wheel hub (17) by means of the third connecting flange.

16. A drivetrain test bench (2) for a drivetrain, comprising at least one test wheel (1) according to claim 1.
